(19) United States
(12) Patent Application Publication
(10) Pub. No.: US 2026/0023582 A1
(43) Pub. Date: Jan. 22, 2026

(54) AUTOMATED COLOR-CODING AND PRIORITIZING IN ADAPTIVE TASK MANAGEMENT SYSTEMS USING CONVERSATIONAL INPUT

(71) Applicant: Celligence International LLC, Guaynabo, PR (US)

(72) Inventors: Pavan Agarwal, Dorado, PR (US); Gabriel Albors Sanchez, San Juan, PR (US)

(73) Assignee: Celligence International LLC, Guaynabo, PR (US)

(21) Appl. No.: 19/275,607

(22) Filed: Jul. 21, 2025

Related U.S. Application Data
(60) Provisional application No. 63/673,466, filed on Jul. 19, 2024.

(51) Int. Cl. G06F 9/451; G06T 11/00

(52) U.S. Cl. CPC G06F 9/453; G06T 11/001; G06T 2200/24

(57) ABSTRACT

Systems and methods are provided for automatically generating prioritized, color-coded tasks based on user input received through a conversation interface of a task management application. User input provided to an automated software assistant is analyzed along with contextual data from multiple sources, including existing tasks, calendar events, emails, and messages. The system determines task attributes such as title, status, deadline, geographic location, urgency, and frequency, and assigns a color tag based on color assignment parameters including task category, priority, and location. Machine learning algorithms analyze historical user-assigned colors in relation to task attributes to predict color assignments for new tasks and establish intelligent color relationships, thereby dynamically updating a prioritized, color-coded task list displayed in a graphical user interface.

### RELATED APPLICATIONS

This application claims the benefit of U.S. Provisional Application No. 63/673,466, filed Jul. 19, 2024, the entirety of which is incorporated herein by reference.

### TECHNICAL FIELD

The present disclosure relates generally to task and productivity management systems, and more particularly, to an intelligent color coding system that leverages machine learning to dynamically assign, suggest, and refine color-coded task categorizations based on user preferences and historical task attributes.

### BACKGROUND

Effective task management often relies on visual cues, such as color coding, to enhance organization, prioritization, and user efficiency. By differentiating tasks with colors, users can more easily scan lists, identify urgent deadlines, or visually group related categories. However, conventional color-coding systems are typically static and require repetitive manual assignments for each new task, even when tasks share similar attributes or contexts. These systems do not learn from historical user behavior, do not adapt over time, and often fail to reflect individual user preferences or evolving priorities.

Furthermore, in multi-application environments-such as when tasks are aggregated from email platforms, calendar events, and messaging tools-traditional solutions provide no harmonization across conflicting color schemes, resulting in fragmented task organization and increased cognitive load for the user.

The disclosed adaptive task management system addresses these limitations by incorporating machine learning techniques to analyze correlations between task titles, content, contextual metadata, and user-assigned colors. By learning from historical patterns, the system intelligently predicts color assignments for new tasks, dynamically adapts to user feedback, and harmonizes visual organization across multiple task sources, thereby improving both usability and computational efficiency.

### SUMMARY

In accordance with one or more embodiments, systems and methods are provided for automatically generating prioritized, color-coded tasks based on user input received via a task management application. The task management application renders both a conversation interface and a graphical user interface (GUI), where the conversation interface allows a user to provide task-related input, such as conversational messages exchanged with an automated software assistant (“AA”), and the GUI displays a prioritized, color-coded task list.

The system is configured to receive a plurality of tasks comprising user messages associated with task text. In response, the system accesses a plurality of task-related data objects residing in one or more task-related databases. These data objects may originate from multiple sources, including previously created tasks, calendar entries, emails, and mobile communications, and may also include location data such as GPS signals. Using text matching between the user-provided task text and associated task-related text, the system identifies relevant task-related data objects and determines one or more task attributes, such as task title, status, deadline, geographic location, urgency, frequency, and similar task attributes.

Based on the determined task attributes, the system predicts an updated prioritized, color-coded ordering of the plurality of tasks using a task prioritization and color-coding machine learning model. Color assignment parameters may include task category or type, task priority, and task location parameters, among others. The machine learning model may be further configured to analyze historical user-assigned colors in relation to task attributes to enable intelligent color predictions for new tasks. Optional models, such as a text recognition model, may determine a task category parameter based on a text string associated with the task, and a location model may determine a task location parameter based on a GPS signal or other contextual data.

The system dynamically updates the GUI to present the plurality of tasks in a prioritized, color-coded task list according to the updated prioritized ordering. In some embodiments, an optimizer feedback loop evaluates user feedback, such as manual color overrides or task reordering, and updates the parsing and machine learning components to improve future predictions. In further embodiments, a harmonization module may normalize color schemes originating from multiple external sources into a unified color taxonomy maintained by the task management application.

Additional features and aspects of the disclosed technology will become apparent from the following detailed description, taken in conjunction with the accompanying drawings, which illustrate, by way of example, various embodiments of the disclosed system and methods. This summary is intended to provide a high-level overview of the disclosed technology and is not intended to limit the scope of the inventions, which are defined solely by the claims.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIGS. 1A illustrates an exemplary automated adaptive task management system architecture, according to an implementation of the disclosure.

FIGS. 1B illustrates the automated adaptive task management system of FIG. 1A in greater detail, according to an implementation of the disclosure.

FIG. 2 illustrates a schematic diagram of a computing component architecture for implementing the automated adaptive task management system of FIG. 1A, according to an implementation of the disclosure.

FIGS. 3A-3D illustrate example user interface views of the adaptive task management application, according to an implementation of the disclosure.

FIG. 4 illustrates an optimizer feedback loop of the adaptive task management system, according to an implementation of the disclosure.

FIG. 5 illustrates an example computing system that may be used in implementing various features of embodiments of the disclosed technology.

Described herein are systems and methods for improving task categorization and prioritization across a variety of heterogeneous data sources by employing machine learning algorithms that analyze user-assigned colors in relation to task titles, content, and contextual metadata. By learning from historical user interactions, the system enables automatic color assignment and establishes intelligent color relationships that adapt over time. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of configurations. Accordingly, the following detailed description is not intended to limit the scope of the disclosure but instead illustrates representative embodiments. While numerous implementation details are provided to facilitate understanding, some embodiments may be practiced without all of the disclosed details. Additionally, known technical elements in the related art have been omitted where they would unnecessarily obscure the understanding of the present disclosure. The embodiments described herein may also be practiced in the absence of elements not explicitly recited.

Color coding has long been used as a visual mechanism to organize tasks based on criteria such as priority, category, or completion status. This improves user productivity by allowing quick identification and filtering of related tasks. For example, high-priority deadlines can be highlighted in a visually distinct manner to reduce the likelihood of overlooking time-sensitive actions. Furthermore, color-based visual organization supports personalization, enabling users to map intuitive color schemes to their workflow, thereby reducing cognitive overhead in task recognition.

In one embodiment, when a user creates or modifies a task, the system may employ a machine learning model to predict an appropriate color assignment based on one or more task color assignment parameters. These parameters can include, without limitation: (i) task category or type derived from task content, email metadata, calendar data, or other communication data; (ii) a priority parameter inferred from task keywords, timing constraints, or related calendar events; and (iii) a location parameter determined from GPS metadata, associated locations in task content, or communication references. For example, work-related tasks may default to a base red color, with variations in saturation indicating urgency (e.g., darker red for high-priority items). Similarly, geographically clustered tasks may share a color family, allowing intuitive recognition of location-based groupings.

While color coding is a proven organizational technique, existing task management applications present several limitations. Many employ static, user-defined color schemes that lack adaptive intelligence, forcing users to repeatedly assign colors manually. Furthermore, conflicting color conventions across multiple task management tools (or messaging applications with auxiliary task features) fragment the user experience and diminish productivity. Most current solutions do not automatically consolidate, categorize, or visually harmonize tasks aggregated from heterogeneous sources.

Conventional task management systems are largely static and rely heavily on user-driven color coding without any adaptive intelligence or contextual awareness. In these systems, colors are assigned manually and stored as fixed metadata with no capacity to learn or evolve over time. As a result, users must repeatedly reassign colors for similar or recurring tasks, which increases workload and reduces overall efficiency. Moreover, existing applications fail to harmonize color schemes across multiple task sources, such as email, calendars, and messaging tools, often resulting in conflicting or fragmented color associations that create cognitive overload. These conventional solutions also lack any meaningful inference based on task content, related communications, deadlines, or geographic metadata, and they consume unnecessary computing resources by redundantly rendering and managing color assignments without optimization or consolidation.

By contrast, the disclosed embodiments introduce technical improvements to computing systems and task management software that go beyond simple automation of manual color coding. The adaptive task management system described herein employs a machine learning engine that dynamically correlates newly created tasks with contextual metadata, including task content, communication data, location signals, and historical priority levels, to predict appropriate color assignments. In doing so, the system significantly reduces redundant user operations by intelligently suggesting or auto-assigning colors for tasks sharing similar characteristics, thereby streamlining human-computer interaction workflows. Additionally, the system optimizes computational efficiency by adaptively updating only the relevant portions of the learned color model, conserving memory, processor cycles, and network bandwidth during synchronization across cloud or multi-device environments. It also harmonizes color schemes across disparate sources, reducing fragmentation and improving the consistency of Ul rendering. As a result, the system enhances the overall performance of task management applications by enabling faster task retrieval, more consistent visual categorization, and fewer manual corrections over time. These technical features collectively provide a concrete technical solution to a technical problem in computing environments, improving the functionality of computing devices by reducing repetitive user inputs, optimizing computing resource utilization, and enabling adaptive categorization for large-scale, cross-application task management.

The disclosed embodiments address these technical deficiencies by providing an automated and adaptive task management system capable of learning from user behavior and dynamically applying color-coding logic. In doing so, the system improves the performance and usability of task management software by reducing redundant manual actions, minimizing conflicting color schemes, and automatically harmonizing task visualizations across disparate sources.

in particular, the technical improvements described herein leverage machine learning models to correlate incoming tasks with contextual metadata (e.g., related communications, historical priority rankings, or location data), enabling highly accurate categorization, prioritization, and color assignment. By integrating with various data sources, the system generates a more holistic understanding of task relevance and urgency, improving the accuracy of predictions while conserving computing resources through adaptive retraining. Over time, the system's task-coloring model becomes increasingly precise, reducing user corrections and streamlining the categorization process. These technical improvements yield practical benefits, such as reducing processor cycles required for redundant task sorting, minimizing network bandwidth when synchronizing task updates, and improving memory efficiency by consolidating redundant color metadata.

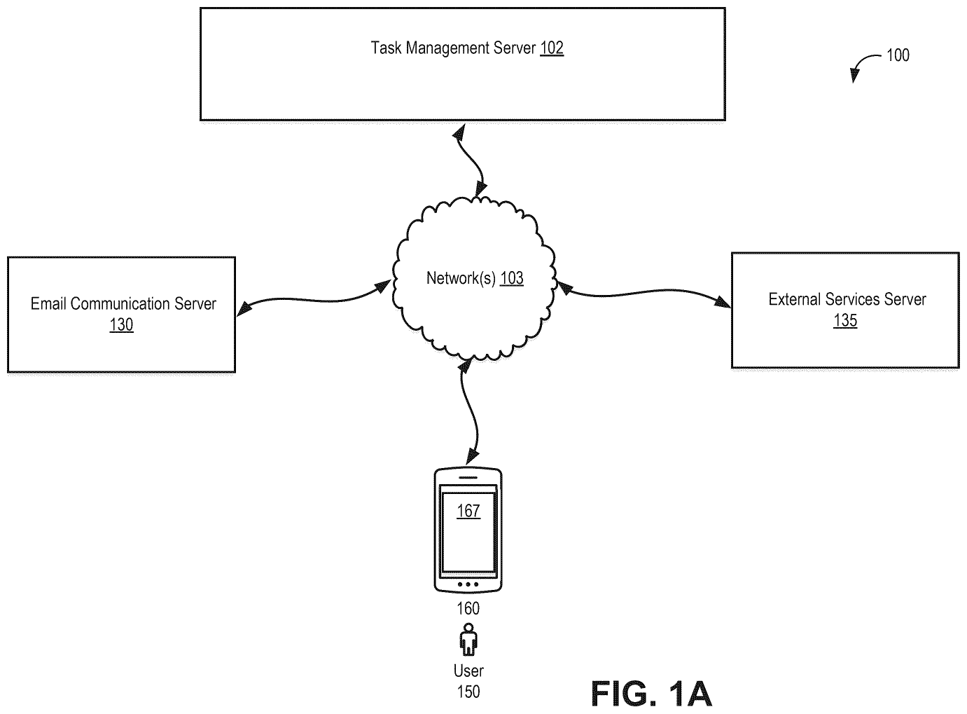

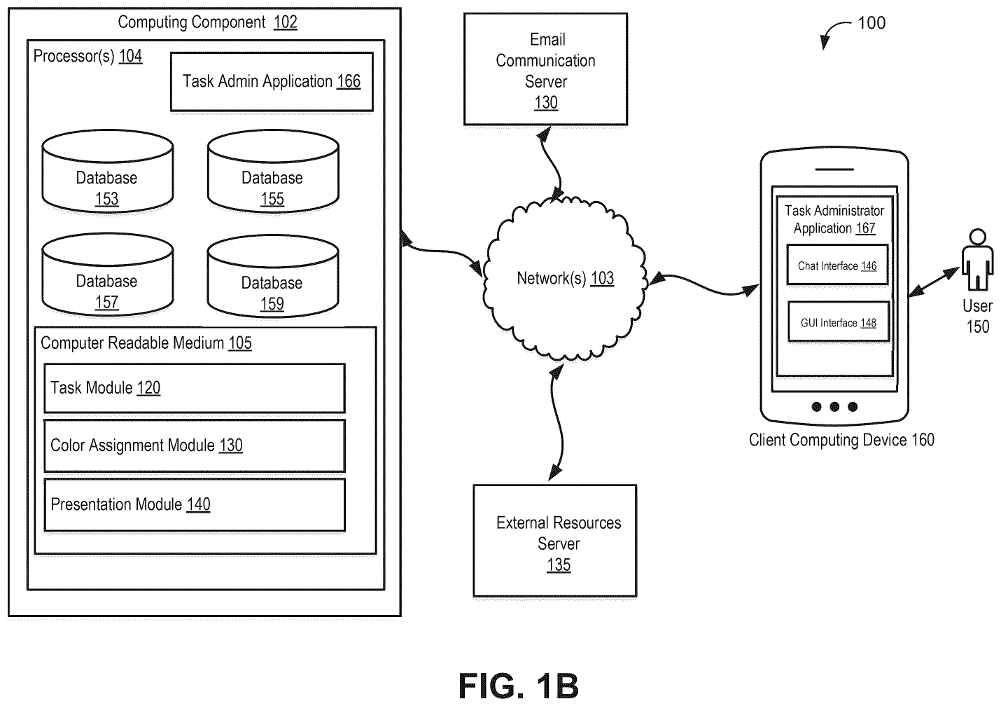

### FIG. 1A

FIG. 1A illustrates an exemplary adaptive task management system 100 configured to provide intelligent task categorization and color assignment based on user input received during a chat-based conversation with an intelligent automated assistant (“AA”), in accordance with the disclosed embodiments. In some implementations, adaptive task management system 100 may integrate with existing scheduling tools and communication data sources associated with a user to facilitate consolidated task categorization across multiple programs and applications. By accessing and harmonizing these data sources, the system enables adaptive task management services that dynamically classify tasks and assign contextual color codes in real time.

In one embodiment, the adaptive task management services analyze incoming user input, which may include the details of a prospective task captured during a conversation with the AA. The input may be considered alongside other available task-related information such as existing tasks, schedules, calendar events, emails, and mobile communication application data. Based on this combined context, the system may (i) determine one or more task attributes, such as a task title, status, deadline, geographic location, urgency, or frequency; (ii) determine corresponding color assignment parameters, including task category or type, priority, and location-based parameters; (iii) generate a structured new task record with the derived attributes; (iv) assign an appropriate color to the task using machine learning-driven color prediction; and (v) present the categorized and color-coded task within a graphical user interface (“GUI”) running on a client computing device 160.

In some embodiments, system 100 comprises a task management server 102 in communication with one or more networks 103. The system may further include one or more email communication servers 130, one or more external services servers 135, and at least one client computing device 160 associated with a user 150, all communicatively coupled via network 103.

In various embodiments, users of system 100 may access the task management services via client computing device(s) 160. The device may execute application 167, which in turn provides a chat-based interface 146 to receive conversational user inputs and a GUI 148 for visual task management. The GUI 148 may present tasks in multiple differentiated views, such as grouped by priority, location, or contextual relationship, and may also include an interactive map to display geographically relevant tasks.

In some embodiments, task management server 102 includes at least one processor, memory, and network communication capabilities. Task management server 102 may be implemented as a dedicated hardware server, a virtual machine running in a virtualized environment, or a cloud-based service accessible over network 103. The server may transmit and receive information to and from the client computing device 160, the email communication servers 130, and the external services servers 135 to aggregate relevant task-related metadata and provide adaptive categorization services.

As shown further in FIG. 1B, task management server 102 may execute program components that enable automated task administration and may provide conversational AA functionality via application 167. These components facilitate contextual parsing of conversational inputs, retrieval of external data, and dynamic task creation with color assignment logic.

In some embodiments, one or more external services servers 135 may provide supplemental services, such as human expert support, bot-based task enrichment, or API-based integrations with third-party calendars, messaging platforms, and other productivity tools.

External services servers 135 may comprise processors, memory, and network communication interfaces and may communicate with task management server 102 and client computing devices 160 using wired (e.g., Ethernet, fiber-optic) or wireless (e.g., Wi-Fi, Bluetooth) connections. These servers may be controlled by the same entity managing the task management server 102 or operated by third parties.

Client computing device 160 may be any electronic computing device capable of presenting content to user 150 and receiving conversational input. Examples include smartphones, tablets, laptops, desktop computers, wearable devices, televisions, AR/VR headsets, and Internet of Things (IOT) devices. In some embodiments, the device may locally parse and preprocess conversational input before transmitting relevant task creation data to the task management server 102.

In some implementations, client computing device 160 may also include geolocation tracking capabilities (e.g., GPS). This location information may be transmitted to the task management server 102 or other servers via network 103 to inform the determination of location-specific task attributes and priority parameters. For example, geographically clustered tasks may be grouped and color-coded to visually indicate spatial relevance.

Email communication servers 130 may likewise include processors, memory, and network interfaces. These servers may transmit metadata or parsed email content between task management server 102 and client computing device 160 for the purpose of extracting and contextualizing task-related details, such as deadlines or action items embedded in emails.

In some embodiments, standardized application programming interfaces (APIs) facilitate integration and secure communication among the task management server 102, external services servers 135, email communication servers 130, and application 167.

### FIG. 1B

FIG. 1B illustrates an example of a task management server 102 configured in accordance with certain embodiments. The server may include one or more processors 124, which may comprise CPUs, semiconductor-based microprocessors, or other specialized hardware capable of retrieving and executing instructions stored in a machine-readable storage medium 105. In some implementations, processor(s) 124 may fetch, decode, and execute instructions to perform real-time operations that optimize system behavior during runtime. Alternatively, or in addition, processor(s) 124 may include one or more electronic circuits, such as field programmable gate arrays (FPGAs) or application-specific integrated circuits (ASICs), preconfigured to perform some or all of the disclosed functions.

A computer-readable storage medium, such as machine-readable storage medium 105, may be any suitable non-transitory storage device capable of storing executable instructions. Examples include volatile or nonvolatile memory such as RAM, NVRAM, EEPROM, flash storage, optical media, or other physical media. Machine-readable storage medium 105 may be encoded with executable instructions—including instructions for modules 120, 130, and 140—responsible for carrying out the adaptive task management processes described herein.

In some embodiments, the computing environment 102 may host one or more distributed applications, where client-facing components (e.g., chat interface applications) execute on a client computing device 160 while server-side logic processes contextual data and maintains task categorization intelligence.

A distributed conversation administration application 166 may operate on processor(s) 124 and execute instructions from storage medium 105, enabling application components such as a parameter and task module 120, a color assignment module 130, and a task presentation and management module 140. These modules work together to parse conversational input, derive task attributes, determine color assignment parameters, and render appropriate visualizations for the user.

A corresponding client application 167 may run on a client computing device 160 and provide an interface for generating new tasks through a chat-based interface 146 while simultaneously displaying a graphical user interface (GUI) 148 for visualizing and managing existing tasks.

In some implementations, automated assistants or bots may be embedded within the chat interface 146 of the distributed chat application 166. These assistants can interact with users in natural language, capturing conversational task details and translating them into structured task attributes.

Through the GUI associated with the distributed chat interface application 167, a user may create new tasks, automatically trigger color assignment, review color-tagged tasks, and override or modify system-assigned colors as needed. The GUI may also present interactive visualizations, including list views, priority-based sorting, and even geospatial task maps.

The chat interface 146 may therefore serve as a natural language layer for interacting with the automated software assistant (AA), while the GUI 148 allows manual review, filtering, and editing of task data. In some cases, the AA may be provided by a third-party assistant platform, separate from the entity that provides the task management application 167.

In one embodiment, these automated assistants are configured to reduce repetitive user operations by suggesting task attributes (such as due dates or categories) and proposing an appropriate color assignment for new tasks, while still enabling user overrides.

To improve prediction accuracy, the adaptive task management system 100 aggregates and correlates data from multiple sources related to the user's tasks, schedule, and communications. These data sources include a task database 153, a calendar database 155, an email database 157, and a mobile communication database 159. By unifying direct conversational input with indirect contextual signals, the system can more accurately determine relevant task characteristics for categorization and color-tag assignment.

The task database 153 may maintain a history of user tasks, including user-assigned colors, start and completion times, subject, purpose, and any collaborators. In some embodiments, this history is synchronized from existing task management or tracking platforms.

The calendar database 155 may store a user's virtual calendar, which could include scheduled meetings, appointments, out-of-office periods, working hours, or other calendar-related data. Information such as meeting availability, cancellations, or rescheduling may be leveraged to infer task urgency or priority. Supported calendar programs may include Google Calendar, Apple Calendar, Microsoft Outlook, and others.

Similarly, the email database 157 may contain a corpus of user emails along with associated metadata (e.g., senders, recipients, timestamps, subjects, attachments). These emails may reveal latent tasks (e.g., “Please review this by Friday”) and inform color assignment based on prior patterns. Supported email services include Gmail, Apple Mail, Outlook, and others.

The mobile communication database 159 may contain metadata and content of mobile messages, such as SMS, WhatsApp, iMessage, or other messaging services. The system can detect action items or implicit tasks within these conversations and assign appropriate task parameters and colors.

As used herein, “database” refers broadly to any centralized or distributed storage system. A database may be implemented via a traditional database management system (DBMS), a distributed ledger (e.g., blockchain), or another suitable storage architecture. In some embodiments, the DBMS may enforce schema definitions, handle query optimization, and provide additional capabilities such as rule enforcement, backup, security, and metadata management. Examples include Oracle, MySQL, PostgreSQL, Microsoft SQL Server, or NoSQL systems.

Within the server environment, a parameter and task module 120 determines task attributes such as category, priority, location, urgency, deadline, and frequency. Direct task-related data may include user-provided conversational input, attached files, urgency markers, or contextual tags. Indirect task-related data may include calendar events, meeting schedules, emails, or messages retrieved from one or more of the aforementioned databases.

The module 120 then generates a structured task record comprising these attributes, which may include a category or type (e.g., work, personal), a relative priority order, a status (e.g., completed, pending), deadlines, and task recurrence frequency.

A color assignment module 130 uses the determined task parameters and applies machine learning models to predict or suggest a color tag for the task. The module leverages both direct conversational input and contextual data from the task, calendar, email, and messaging databases to infer user color preferences. In some implementations, Al models trained on historical user interactions identify semantic similarities and assign colors accordingly, optionally generating shades or variations to prevent duplication while maintaining visual relationships.

Finally, a task presentation and management module 140 renders the categorized and color-coded tasks within the client-facing GUI, enabling users to view tasks by priority, category, or location, and make adjustments as needed.

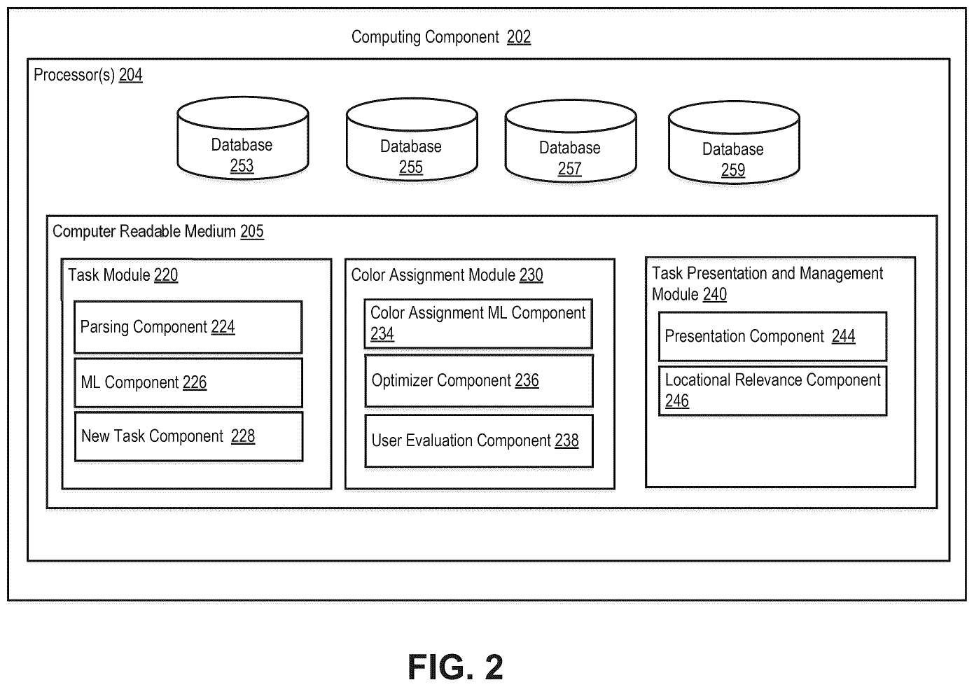

### FIG. 2

As illustrated in FIG. 2, a computing component 202 includes at least one hardware processor 204 configured to execute instructions stored in a machine-readable storage medium 105. These instructions implement various computer program components that together enable adaptive task categorization and color assignment. The processor 204 may fetch, decode, and execute instructions corresponding to a parameter and attribute module 220, a color assignment module 230, and a presentation and management module 240.

The parameter and attribute module 220 governs processes for determining task attributes, predicting task-related parameters, and automatically generating structured task records. The module 220 communicates with one or more contextual data sources, including a task database 253, a calendar database 255, an email database 257, and a mobile communication database 259. Each database may store task-related information in formats such as tables, tuples, arrays, or text, and may also include metadata describing data origin, destination, timestamps, location, and source identifiers. By unifying this diverse information, the module can holistically analyze both direct and indirect signals to derive meaningful task attributes.

In some embodiments, the module 220 leverages these databases and their associated metadata to determine and predict task priority. This includes identifying time-sensitive tasks, tasks requiring immediate attention based on scheduling conflicts, or tasks likely to be critical due to historical patterns. The module may analyze data such as meeting times, communication senders or recipients, open work items, and urgency indicators.

Beyond priority, module 220 predicts task categories (e.g., work, personal, social), priority levels (e.g., high, medium, low), and task locations by applying parsing and machine learning components. Specifically, the parsing component 224 receives raw input from user conversations, related calendar events, emails, and other communications, while the machine learning component 226 deduces correlations between the parsed data and probable task parameters.

Each of the parsing component 224 and the machine learning component 226 may be implemented in software, hardware, or a combination thereof. For example, the parsing component 224 may execute natural language parsing algorithms to process text-based inputs, while the machine learning component 226 may execute predictive models for task categorization and priority estimation. In some embodiments, the parsing component 224 includes processors and memory preconfigured with instructions for extracting structured features from unstructured conversational text.

The parsing component 224 transforms various data inputs—such as user messages, related threads, calendar events, and historical task metadata—into normalized feature vectors or feature maps. These representations capture semantic and contextual meaning, enabling the machine learning component 226 to generate task attributes from multi-modal data. Once extracted, the features are passed to the machine learning component 226, which predicts color assignment parameters (e.g., task category, task priority, and task location) based on learned user patterns.

Data parsing and feature extraction techniques may vary depending on the data type. For text data, natural language processing models may be applied. For structured data such as tables or arrays, parsing may directly extract feature values. In cases where both character strings and structured elements coexist, the parsing component may use a hybrid approach, parsing text to extract semantic meaning before combining it with structured metadata to produce comprehensive feature vectors.

Feature extraction may employ various dimensionality reduction or embedding techniques, such as principal component analysis (PCA), kernel PCA, latent semantic analysis, autoencoding, or word embedding models like Word2Vec or GloVe. As a result, the parsing component 224 produces feature vectors that capture semantic meaning, frequency of keywords, temporal details (e.g., due dates), and other contextual elements. For instance, the textual title of a task may be vectorized using bag-of-words, TF-IDF, or embeddings, while temporal features may be represented numerically (e.g., days until due) or categorically (e.g., overdue, due soon, long-term).

Additional features may represent task metadata such as priority level (encoded categorically as high, medium, or low), estimated task duration (encoded numerically), completion status (not started, in progress, completed), assigned tags or keywords (e.g., “meeting,” “email”), or historical user interaction data (e.g., typical completion times). Contextual signals like the user's current location, device, or time of day may also be encoded as features. Together, these features allow the machine learning component 226 to generate personalized and context-aware predictions for each user.

The machine learning component 226 consumes these feature vectors to predict task priority values on a continuous or categorical scale. For example, tasks may be scored numerically from 1 to 10, where lower scores represent higher urgency. Lists of tasks can then be sorted or filtered according to these predicted priority parameters, allowing tasks to be presented in descending or ascending priority order within a graphical user interface.

In some implementations, the machine learning component 226 applies classification models to predict task priority and category based on availability signals, historical task behaviors, and calendar metadata. The prediction process yields a priority parameter that reflects the relative urgency or importance of each task compared to others.

For certain embodiments, the machine learning component 226 may include neural network architectures, such as convolutional neural networks (CNNs), that accept feature maps as input, apply convolutional layers to weight relationships between features, and output predictions for both task category and task priority simultaneously.

The parsing component 224 may also extract geographic signals that allow the machine learning component 226 to predict a location attribute associated with a task. For example, if the user says “start looking for a house,” location data retrieved from the client device's GPS may be fused with the parsed text to generate a specific location-aware task title, such as “search for houses in Los Angeles County.”

Predicted or determined geographic locations are then used to generate a location parameter for color assignment. In some embodiments, the location can be inferred contextually from the user's conversation or extracted directly from GPS data or explicit user input such as a postal code.

Task priority can also dynamically adjust based on the user's changing location. As the user moves geographically, tasks relevant to the new location may be prioritized visually within the interface. This ensures that spatially relevant tasks are surfaced prominently when needed, further improving contextual efficiency in task management.

Beyond category, priority, and location, the machine learning component 226 may predict other task attributes, such as deadlines (e.g., urgent vs. distant), urgency (e.g., high, medium, low), frequency (e.g., daily, weekly), and completion status. This holistic attribute prediction enriches the system's ability to present an organized and color-coded task list.

Once attributes are determined, a new task component 228 generates a structured task record. For example, tasks of higher predicted priority may later be rendered in more intense color shades (e.g., high-priority tasks in dark red, medium priority in orange or yellow, and low priority in green).

The color assignment module 230 receives attribute data from module 220 and uses a task color assignment machine learning component 234, together with an optimizer component 236, to determine the most probable color for each task relative to other tasks with similar attributes. This ensures color consistency within a category while maintaining distinguishable shades for sub-priorities or sub-locations.

The color assignment machine learning component 234 converts the predicted category and priority parameters into a specific color code. The task, along with its color code, is transmitted to the user's client computing device (e.g., device 160 from FIG. 1) for presentation. In some embodiments, the task's color intensity may dynamically represent its relative priority within a list, ensuring a visually intuitive hierarchy.

The optimizer component 236 refines the predictions of the color assignment model by incorporating user feedback collected via a user evaluation component 238. For instance, if a user changes a system-assigned color or reorders tasks differently than predicted, this interaction acts as corrective feedback. The optimizer component 236 evaluates the difference between the predicted color priority and the user's actual behavior (the “ground truth”) and propagates an error signal back through the ML model.

Feedback loops allow on-line learning, where the optimizer component 236 incrementally updates the parsing component 224 and machine learning component 226 to improve future predictions. For example, if two tasks within the same color family are presented, but the user consistently interacts with one first, the optimizer re-weights model parameters to reflect this behavioral priority pattern.

After processing by the ML and color assignment modules, the presentation and management module 240 generates the final visual representation of the categorized, color-coded tasks. Tasks are rendered within a GUI on the client device, grouped or sorted by parameters like priority, category, or location.

The presentation module 240 supports multiple user views, including a standard prioritized list view and a geospatial map view for tasks with location parameters.

A presentation component 244 ensures tasks are visually organized in an intuitive, user-friendly manner, maintaining consistency with the learned color coding logic.

A location relevance component 246 dynamically updates the displayed tasks based on the user's real-time location. For example, as the user travels, the system may re-rank tasks to highlight those most relevant to the current geographic context.

This adaptive behavior helps users focus on tasks that are most pertinent in their immediate context. By leveraging GPS or other location signals, the location relevance component 246 ensures the task list and map view remain synchronized with the user's environment, further enhancing task prioritization and visual clarity.

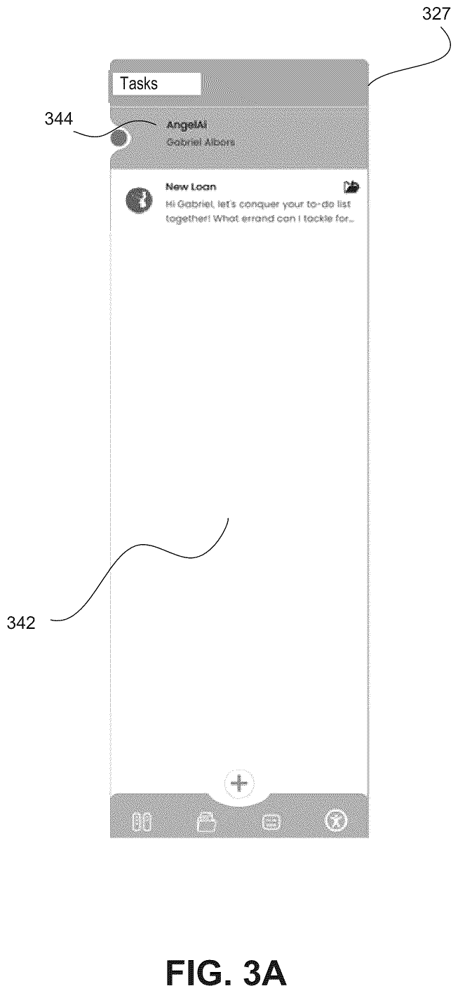

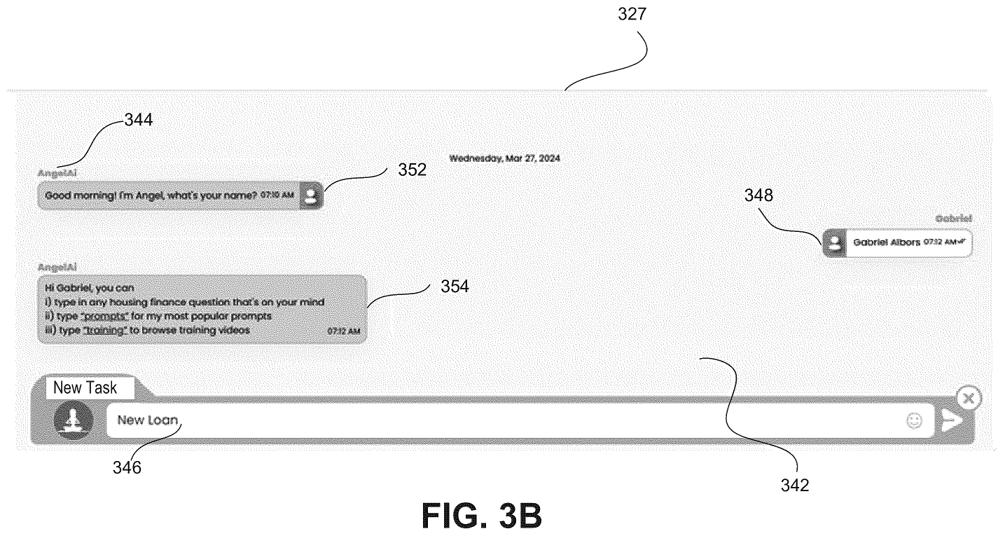

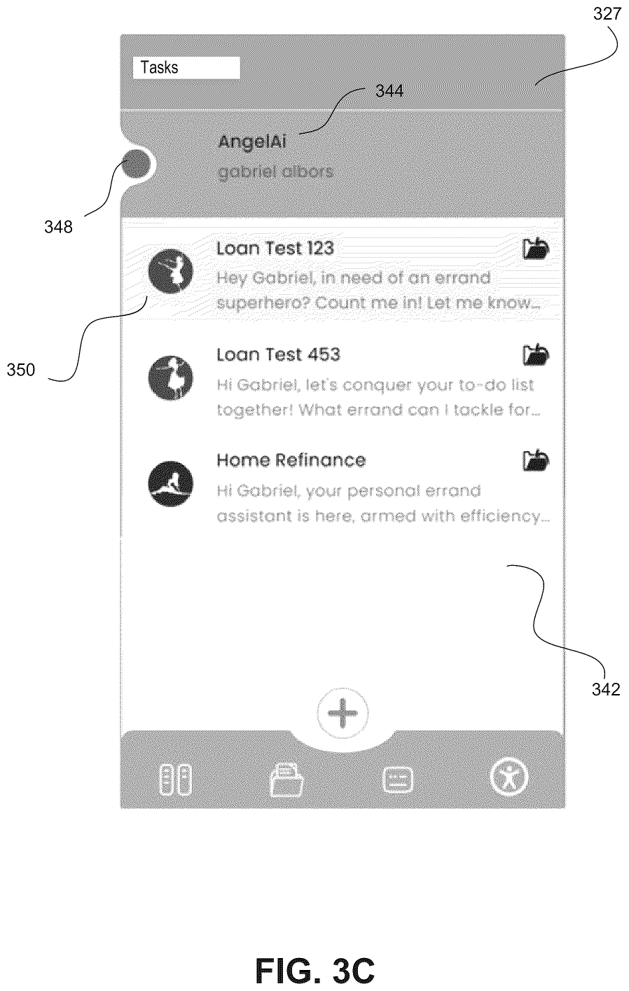

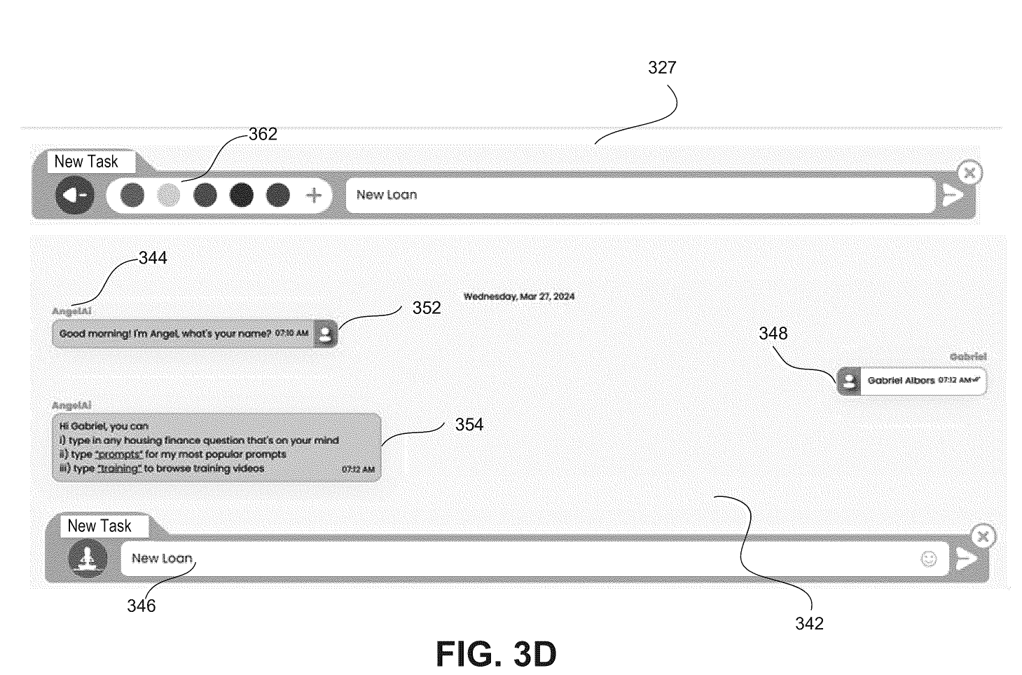

### FIGS. 3A-3D

FIGS. 3A-3C illustrate an example implementation of the adaptive task management application 327 executing on a client computing device 160. In FIG. 3A, a user 329 is engaging with the task management application through a chat interface 342, communicating with an intelligent automated assistant (AA) 344. The chat interface serves as a conversational layer that allows the user to create new tasks and receive system-generated prompts in natural language.

[As shown in FIG. 3B, the AA 344 responds dynamically to user inputs by sending conversational messages 352 and 354 in reply to a user-initiated message 348. The user may create a task by either entering the task details directly as a chat message (such as message 348) or by typing the details into a dedicated task entry window 346 within the same interface. Upon receiving the user's input, the system invokes the parameter and task modules described in FIGS. 1B and 2—namely, the parameter and task module 120 (FIG. 1B) or module 220 (FIG. 2)—to extract and predict relevant task attributes. These task attributes are then processed by the color assignment modules 130 (FIG. 1B) or 230 (FIG. 2), which determine the appropriate color assignment parameters. Based on these parameters, the system automatically assigns a contextually relevant color tag to the new task.

For example, FIG. 3C illustrates the task “New Loan” created in FIG. 3B, which has been automatically assigned an orange color 348. This color assignment reflects the priority, category, or other contextual parameters inferred from the conversation. Alternatively, as shown in FIG. 3D, the user 329 may override the system's suggested color by using an interactive color selection feature 362, allowing manual customization. This ensures that while the system automates color-coding, the user retains ultimate control over task categorization.

In some embodiments, additional backend logic may proactively generate tasks without requiring direct user input. For instance, a task administrator module (not explicitly illustrated in any of FIGS. 3A-3D) may create tasks based on detected events or triggers within the user's data sources.

More specifically, the parameter and task module 120 of the adaptive task management system 100 may be configured to determine task attributes based not only on direct user-entered data but also on indirect task-related data. Such indirect data may include existing tasks, calendar events, meeting schedules, emails, or messages retrieved from databases 153, 155, 157, and 159 (as described with reference to FIG. 1B). Additionally, the system may aggregate inputs from specialized domain-specific AA programs.

For example, when a user is interacting with a specialized AA—such as a mortgage assistant—the assistant may detect implicit tasks and transmit them to the parameter and task module 120. During a mortgage application process, if the user is required to submit tax records, the mortgage AA may forward this requirement as a structured task. The adaptive system would then generate a new task titled “Send Mortgage Platform Bank and Tax Documents” with appropriate attributes and color parameters already pre-determined.

Similarly, indirect task-related data can result in task prompts automatically appearing within the main chat interface 146 of the task management AA. For example, specialized AA programs may push reminders like “Get your April bank statement” or “Upload tax returns” directly into the user's chat log for immediate attention. The user may also interact with specialized task icons (e.g., “Send Documents”), enabling quick attachment of files or submission of supporting materials directly within the conversational flow.

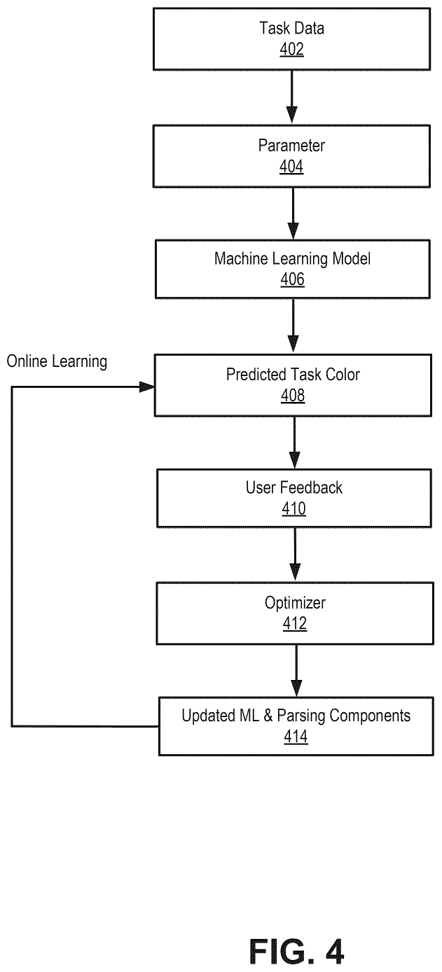

### FIG. 4

FIG. 4 illustrates an exemplary optimizer feedback loop architecture implemented within the adaptive task management system. In this embodiment, the process begins with task data 402, which may include user-entered task information, indirect contextual data from communication sources, calendar events, or historical task metadata, as previously described with reference to FIGS. 1B and 2. The task data 402 is processed to extract task parameters 404, such as category, priority, deadline, urgency, and location signals.

These parameters are provided to a machine learning model 406, which is configured to predict an appropriate task color 408 for the new or updated task. The machine learning model may utilize techniques such as neural networks, support vector machines, or other classification and regression algorithms, trained on historical user behavior and contextual metadata. The output is a predicted color tag or shade representing the category, priority, or contextual grouping of the task, which is then presented within the user interface of the client computing device.

Once the predicted task color 408 is displayed, the system receives user feedback 410, which may include explicit actions such as manually changing the assigned color, reordering tasks, marking tasks as more urgent, or implicitly indicating priority by interacting with certain tasks before others. User feedback 410 therefore reflects a “ground truth” that reveals whether the system's predictions align with actual user preferences or contextual priorities.

The collected user feedback 410 is routed to an optimizer 412, which evaluates discrepancies between the predicted task color and the user's actual behavior. The optimizer 412 computes an error signal that quantifies the deviation between predicted and desired outcomes. For example, if the system predicted a medium-priority color (e.g., orange) but the user immediately promoted the task to a high-priority category (e.g., dark red), the optimizer 412 determines an error corresponding to the misclassification of priority intensity.

The optimizer 412 uses this error to update and refine both the parsing components and the machine learning components 414 in an online learning fashion. Specifically, the optimizer may backpropagate adjustments to the feature extraction models within the parsing component 224 and retrain or fine-tune the machine learning component 226 responsible for task attribute prediction. This ensures that future predictions better reflect the evolving user preferences and contextual patterns.

Once the ML and parsing components 414 are updated, they are re-integrated into the prediction pipeline, allowing subsequent tasks processed by the system to benefit from improved accuracy and personalization. This continuous feedback loop supports online adaptive learning, enabling the system to incrementally optimize color assignment predictions without requiring offline batch retraining.

Through this iterative process, the adaptive task management system incrementally reduces the frequency of incorrect predictions over time, minimizing redundant user corrections, improving user satisfaction, and conserving computational resources by reducing unnecessary processing cycles. Moreover, this approach harmonizes color-coding logic across different task sources (e.g., email, calendar, messaging), leading to a more consistent and intelligent task management experience.

In some embodiments, the adaptive task management system may further include a Harmonization Module configured to resolve conflicting color schemes across multiple external applications and services. As described in FIGS. 1B and 2, the system may aggregate tasks from heterogeneous sources such as calendar applications, email clients, and messaging platforms. Each of these sources may utilize distinct or incompatible color-coding conventions for categorizing tasks or events, leading to fragmented visual organization when viewed collectively.

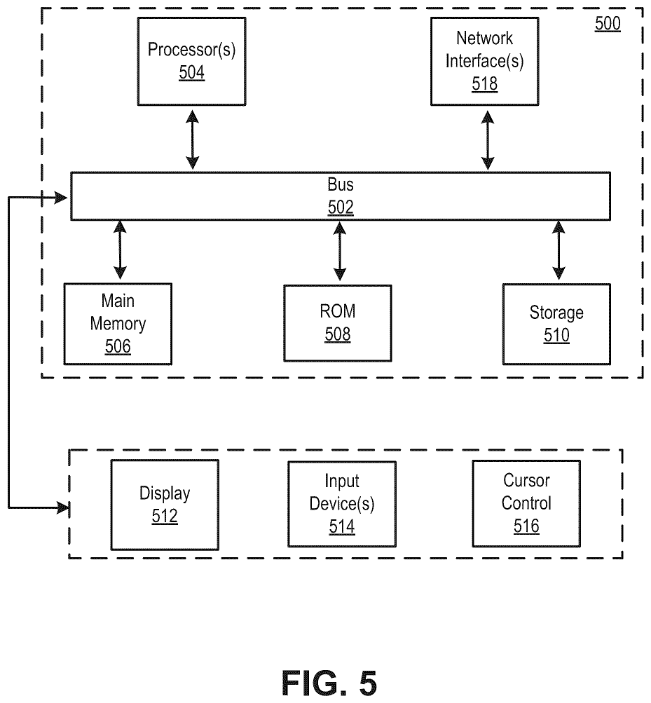

The Harmonization Module operates in conjunction with the Optimizer 412 and the updated parsing and machine learning components 414 (FIG. 5) to dynamically normalize and remap disparate color codes into a unified color taxonomy. In some embodiments, the module maintains a cross-referencing color schema that translates third-party platform colors into standardized color families used by the adaptive task management system. For example, if one external platform represents “urgent tasks” as bright yellow while another uses bright red, the Harmonization Module may infer equivalency and normalize both to a high-priority color family (e.g., red with varying intensity levels).

To perform this normalization, the Harmonization Module may leverage the same feature vectors generated by the parsing component 224. It compares contextual metadata such as task titles, associated deadlines, user-specific historical overrides, and the external source's predefined priority levels to determine semantic equivalence. Based on these relationships, the module generates a harmonization mapping table that ensures consistency between external and internal task representations.

In some embodiments, the Harmonization Module also feeds harmonized data back into the Optimizer 412 for iterative refinement. If a user repeatedly overrides the harmonized color mapping for tasks originating from a specific platform, the optimizer evaluates this behavior and updates the harmonization mapping table accordingly. Over time, the system self-adjusts to the user's personal preferences while maintaining a globally consistent visual language for all aggregated tasks.

By eliminating color conflicts across multiple platforms, the Harmonization Module reduces the user's cognitive load and improves interface clarity. Moreover, by standardizing colors at the system level, the adaptive task management application minimizes redundant computations for re-rendering external data and enhances Ul rendering efficiency across multi-device environments.

### FIG. 5

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 5. Various embodiments are described in terms of this example computing module 500. After reading this description, it will become apparent to a person skilled in the relevant art how to implement the technology using other logical circuits or architectures.

FIG. 5 illustrates an example computing module 500, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the application using other computing modules or architectures.

Referring now to FIG. 5, computing module 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally. The bus 502 may also be connected to other components such as a display 512, input devices 514, or cursor control 516 to help facilitate interaction and communications between the processor and/or other components of the computing module 500.

Computing module 500 might also include one or more memory modules, simply referred to herein as main memory 506. For example, preferably random-access memory (RAM) or other dynamic memory might be used for storing information and instructions to be executed by processor 504. Main memory 506 might also be used for storing temporary variables or other intermediate information during execution of instructions to be executed by processor 504. Computing module 500 might likewise include a read only memory (“ROM”) 508 or other static storage device 510 coupled to bus 502 for storing static information and instructions for processor 504.

Computing module 500 might also include one or more various forms of information storage devices 510, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 510 might include other similar instrumentalities for allowing computer programs or other instructions or data to be loaded into computing module 500. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 500.

Computing module 500 might also include a communications interface or network interface(s) 518. Communications or network interface(s) interface 518 might be used to allow software and data to be transferred between computing module 500 and external devices. Examples of communications interface or network interface(s) 518 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 518 might typically be carried on signals, which can be electronic, electromagnetic (which includes optical) or other signals capable of being exchanged by a given communications interface. These signals might be provided to communications interface 518 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 506, ROM 508, and storage unit interface 510. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method comprising, comprising:
rendering, by at least one processor, a conversation interface and a graphical user interface (GUI) of a task management application, the task management application being configured to receive a plurality of tasks;
wherein the plurality of tasks comprises a plurality of user messages received via the conversation interface, each user message being associated with a task text;
wherein the GUI comprises a prioritized, color-coded task list that displays the plurality of tasks in an order according to a current prioritized ordering of the plurality of tasks, each priority level within the current prioritized ordering being associated with a corresponding color tag;
dynamically updating, by the at least one processor, the current prioritized color-coded ordering of the plurality of tasks by:
accessing a plurality of task-related data objects stored in at least one task-related database, the plurality of task-related data objects being associated with at least one task-related text and including at least one additional task object;
determining, based at least in part on a matching between the task text and the task-related text, at least one task-related data object of the plurality of task-related data objects associated with at least one task of the plurality of tasks;
utilizing a task prioritization and color-coding machine learning model to predict an updated prioritized, color-coded ordering of the plurality of tasks based at least in part on at least one parameter associated with each of the plurality of tasks, the at least one parameter comprising at least one task-related data object parameter representing the at least one task-related data object associated with the respective task; and
updating the GUI to display the prioritized, color-coded task list according to the updated prioritized ordering.

2. The method of claim 1, further comprising utilizing, by the at least one processor, a text recognition model to determine at least one task category parameter of the respective task.

3. The method of claim 2, wherein the at least one task category parameter of the respective task is based on a text string associated with a category of the respective task.

4. The method of claim 3, wherein the updated prioritized, color-coded ordering of the plurality of tasks predicted by the task prioritization and color-coding machine learning model is further based on the task category parameter.

5. The method of claim 1, further comprising utilizing, by the at least one processor, a location model to determine at least one task location parameter of the respective task.

6. The method of claim 5, wherein the at least one task location parameter of the respective task is determined based at least in part on a GPS signal associated with a user-operated device used to generate the plurality of user messages received by the conversation interface of the task management application.

7. The method of claim 6, wherein the updated prioritized, color-coded ordering of the plurality of tasks predicted by the task prioritization and color-coding machine learning model is further based on the task location parameter.

8. The method of claim 1, wherein the user input comprises conversational messages exchanged with an automated software assistant (“AA”) within the conversation interface of the task management application.

9. The method of claim 1, further comprising:
receiving, by the at least one processor, user feedback indicating an adjustment to the predicted color tag or a change in the ordering of the plurality of tasks;
evaluating, by an optimizer component, a prediction error between the predicted color tag and the user feedback; and
updating, by the optimizer component, at least one of a parsing model or the task prioritization and color-coding machine learning model based on the prediction error to improve subsequent color assignment predictions.

10. The method of claim 1, further comprising normalizing, by a harmonization module, color codes received from a plurality of external task sources into a unified color taxonomy used by the task management application.

11. A system comprising:
one or more computing processors; and
a non-transitory machine-readable storage medium storing instructions that, when executed by the one or more processors, cause the system to:
render a conversation interface and a graphical user interface (GUI) of a task management application, the task management application being configured to receive a plurality of tasks;
wherein the plurality of tasks comprises a plurality of user messages received by the conversation interface, each user message being associated with a task text;
display, in the GUI, a prioritized color-coded task list that presents the plurality of tasks in an order according to a current prioritized ordering of the plurality of tasks, each priority level within the current prioritized ordering being associated with a corresponding color tag;
dynamically update the current prioritized color-coded ordering of the plurality of tasks by:
accessing a plurality of task-related data objects stored in at least one task-related database, the plurality of task-related data objects being associated with at least one task-related text and including at least one additional task object;
determining, based at least in part on a matching between the task text and the task-related text, at least one task-related data object of the plurality of task-related data objects associated with at least one task of the plurality of tasks;
utilizing a task prioritization and color-coding machine learning model to predict an updated prioritized color-coded ordering of the plurality of tasks based at least in part on at least one parameter associated with each of the plurality of tasks, the at least one parameter comprising at least one task-related data object parameter representing the at least one task-related data object associated with a respective task; and
updating the GUI to present the prioritized color-coded task list according to the updated prioritized ordering.

12. The system of claim 11, wherein the at least one processor is further configured to utilize a text recognition model to determine at least one task category parameter of the respective task.

13. The system of claim 12, wherein the at least one task category parameter of the respective task is determined based on a text string associated with a category of the respective task.

14. The system of claim 13, wherein the updated prioritized color-coded ordering of the plurality of tasks predicted by the task prioritization and color-coding machine learning model is further based on the task category parameter.

15. The system of claim 11, wherein the at least one processor is further configured to utilize a location model to determine at least one task location parameter of the respective task.

16. The system of claim 15, wherein the at least one task location parameter of the respective task is determined based at least in part on a GPS signal associated with a user-operated device used to generate the plurality of user messages received by the conversation interface of the task management application.

17. The system of claim 16, wherein the updated prioritized color-coded ordering of the plurality of tasks predicted by the task prioritization and color-coding machine learning model is further based on the task location parameter.

18. The system of claim 11, wherein the user input comprises conversational messages exchanged with an automated software assistant (“AA”) within the conversation interface of the task management application.

19. The system of claim 11, further comprising an optimizer component configured to:
receive user feedback indicating at least one of a modification to a predicted color tag or a change to an order of the plurality of tasks;
evaluate a prediction error between the predicted color tag and the user feedback; and
update at least one of a parsing model or the task prioritization and color-coding machine learning model based on the prediction error to improve subsequent color assignment predictions.

20. The system of claim 11, further comprising a harmonization module configured to normalize color tags received from a plurality of external task sources into a unified color taxonomy maintained by the task management application, the harmonization module being further configured to adjust the normalized color taxonomy based on historical user overrides of color assignments originating from specific external sources.
